(19) United States
(12) Patent Application Publication
(10) Pub. No.: US 2012/0257012 A1
(43) Pub. Date: Oct. 11, 2012

(54) METHOD AND APPARATUS FOR 3-DIMENSIONAL IMAGE DISPLAY

(75) Inventors: Hui Yong KIM, Daejeon (KR); Suk Hee CHO, Daejeon (KR); Se Yoon JEONG, Daejeon (KR); Sung Chang LIM, Daejeon (KR); Jong Ho KIM, Daejeon (KR); Ha Hyun LEE, Seoul (KR); Jin Ho LEE, Daejeon (KR); Eung Don LEE, Daejeon (KR); Sung Hoon KIM, Daejeon (KR); Jin Soo CHOI, Daejeon (KR); Jin Woong KIM, Daejeon (KR); Chie Teuk AHN, Daejeon (KR)

(73) Assignee: Electronics and Telecommunications Research Institute, Daejeon (KR)

(21) Appl. No.: 13/440,699

(22) Filed: Apr. 5, 2012

(30) Foreign Application Priority Data
Apr. 7, 2011 (KR) 10-2011-0031992

(51) Int. Cl. H04N 13/04; H04N 13/00

(52) U.S. Cl. 348/43; 348/51; 348/E13.026; 348/E13.062

(57) ABSTRACT

A display method and a display apparatus of a 3D image are provided. The display method includes: receiving an image stream; determining a viewing mode of the image stream; determining whether or not a screen of a display apparatus is adjusted according to the determined viewing mode; and adjusting the screen of the display apparatus in the case in which it is determined in the determining of whether or not the screen of the display apparatus is adjusted that the screen is adjusted, wherein the viewing mode of the image stream includes a 2D image viewing mode and a 3D image viewing mode.

### CROSS-REFERENCE TO RELATED APPLICATIONS

This application claims the benefit of priority of Korean Patent Application No. 10-2011-0031992 filed on Apr. 7, 2011, which is incorporated by reference in their entirety herein.

### BACKGROUND OF THE INVENTION

1. Field of the Invention

The present invention relates to a display method and a display apparatus, and more particularly, to a display method and a display apparatus of a 3-dimensional image.

2. Related Art

A 3-dimensional (hereinafter, referred to as 3D) image broadcasting has become recently prominent. The 3D image broadcasting, which is a method of transmitting two images each viewed by a left eye and a right eye of a person and allowing each eye to view different images through a polarizing eyeglass or a time division eyeglass or the like, generates an effect of viewing a 3D image.

As a typical apparatus for displaying a 3D image, there is a 3D television (3D TV). In the case of the 3D TV according to the related art, in order to experience a 3D effect, a viewer wears a polarizing eyeglass or a time division eyeglass (for example, shutter glass eyeglass). Since an additional apparatus such as the eyeglass is used, image quality is deteriorated. For example, the viewer feels that the 3D image has brightness darker than that of a 2D image and it is difficult to perceive the 3D image.

Therefore, in the case in which the 3D image is displayed, a need exists for a method and an apparatus capable of preventing an image quality deterioration phenomenon perceived by the viewer.

### SUMMARY OF THE INVENTION

The present invention provides a method and an apparatus capable of preventing deterioration of a 3D image in the case in which a viewer views a display apparatus of a 3D image using an additional apparatus such as a polarizing eyeglass, or the like.

In an aspect, a display method of a 3D image is provided. The display method includes: receiving an image stream; determining a viewing mode of the image stream; determining whether or not a screen of a display apparatus is adjusted according to the determined viewing mode; and adjusting the screen of the display apparatus in the case in which it is determined in the determining of whether or not the screen of the display apparatus is adjusted that the screen is adjusted, wherein the viewing mode of the image stream includes a 2D image viewing mode and a 3D image viewing mode.

The image stream may include a header including at least one of a view parameter indicating the number of views of a decoded image obtained by decoding the image stream and a dimensional parameter indicating whether the decoded image is a 2D image or a 3D image.

In the determining of the viewing mode of the image stream, the viewing mode of the image stream may be determined using at least one of the view parameter and the dimensional parameter.

In the determining of the viewing mode of the image stream, it may be determined that the viewing mode of the image stream is the 3D image viewing mode in the case in which the number of view parameters is 2 or more, and it may be determined that the viewing mode of the image stream is the 2D image viewing mode in the case in which the number of view parameters is 1 or less.

In the determining of whether or not the screen of the display apparatus is adjusted, it may be determined that the screen is adjusted only in the case in which the determined viewing mode is different from a previous viewing mode.

The adjusting of the screen may include changing at least one of brightness, contrast, hue, saturation, and a Gamma value of the display apparatus.

In the case in which it is determined that the viewing mode of the image stream is the 3D image viewing mode, the brightness of the display apparatus may be adjusted so as to have a value larger than that of brightness set in the 2D image viewing mode.

In another aspect, a display apparatus of a 3D image is provided. The display apparatus includes: a viewing mode determining unit receiving an image stream and determining a viewing mode of the image stream; a screen adjustment determining unit determining whether or not a screen is adjusted according to the viewing mode determined by the viewing mode determining unit; a screen adjusting unit adjusting the screen according to the determination of the screen adjustment determining unit; and a display unit connected to the screen adjusting unit, displaying an image, and receiving image control signals from the screen adjusting unit to adjust a display method of the image, wherein the viewing mode of the image stream includes a 2D image viewing mode and a 3D image viewing mode.

### BRIEF DESCRIPTION OF THE DRAWINGS

FIG. 1 shows a configuration of a display apparatus according to an exemplary embodiment of the present invention.

FIG. 2 shows a hierarchical structure of an image stream.

FIG. 3 shows an example a configuration of an image stream.

FIG. 4 shows an example of determining whether or not a screen is adjusted in the display apparatus according to the exemplary embodiment of the present invention.

FIG. 5 shows another example of determining whether or not a screen is adjusted in the display apparatus according to the exemplary embodiment of the present invention.

### DESCRIPTION OF EXEMPLARY EMBODIMENTS

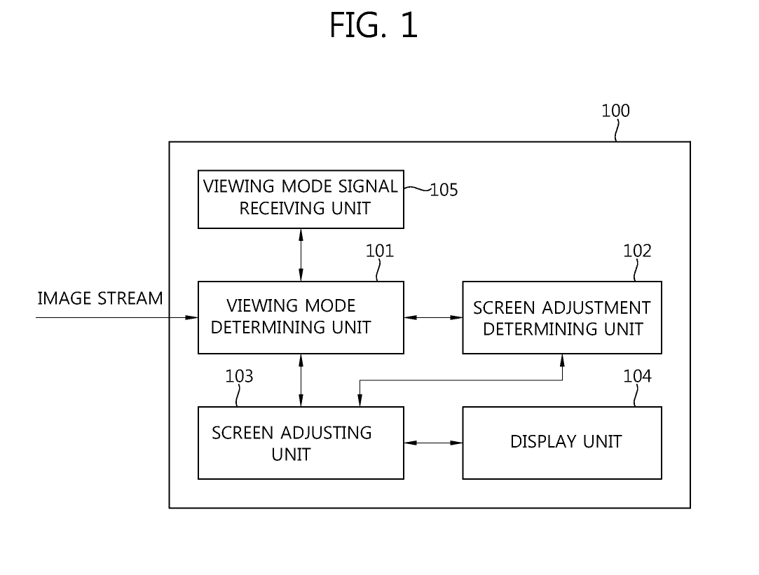

FIG. 1 shows a configuration of a display apparatus according to an exemplary embodiment of the present invention.

Referring to FIG. 1, the display apparatus may include a viewing mode determining unit, a screen adjustment determining unit, a screen adjusting unit, a viewing mode signal receiving unit, and a display unit.

The view mode determining unit determines a viewing mode of an image stream input from the outside. The image stream may include image data on a 2D image or image data on a 3D image. The viewing mode includes a 2D image viewing mode and a 3D image viewing mode. The 2D image viewing mode is a viewing mode for a general image, that is, an image that does not express a 3D effect, and the 3D image viewing mode is a viewing mode for an image that expresses the 3D effect. In the 3D image viewing mode, in the case in which a user views the 3D image using an external apparatus such as a polarizing eyeglass or a time division eyeglass, he/she feels the 3D effect.

The screen adjustment determining unit compares a current viewing mode determined by the viewing mode determining unit with a previous viewing mode or determines whether or not a screen of an image displayed on a display unit using the current viewing mode is adjusted.

The screen adjusting unit adjusts the screen displayed on the display unit. For example, the screen adjusting unit generates image control signals for brightness, contrast, hue, saturation, a Gamma value, and the like, of the image displayed on the display unit and provides the generated image control signals to the display unit.

The viewing mode signal receiving unit, which is a unit receiving control signals for a viewing mode of the image displayed on the display unit, may include a memory capable of storing a viewing mode of the display apparatus therein. For example, the viewing mode signal receiving unit may receive a viewing mode control signal transmitted from a remote controller. Alternatively, the viewing mode signal receiving unit may receive a turn on/off signal of an external apparatus such as a polarizing eyeglass used when the display apparatus is viewed as a viewing mode control signal. For example, in the case in which the polarizing eyeglass is used, when a switch of the polarizing eyeglass is turned on, a polarizing eyeglass turn-on signal may be transmitted to the viewing mode signal receiving unit.

The display unit, which is an apparatus displaying an image, may be implemented as various apparatuses such as a liquid crystal display (LCD), a plasma display panel (PDP), an organic light emitting diode (OLED), or the like.

Hereinafter, a display method of a 3D image using the above-mentioned display apparatus will be described.

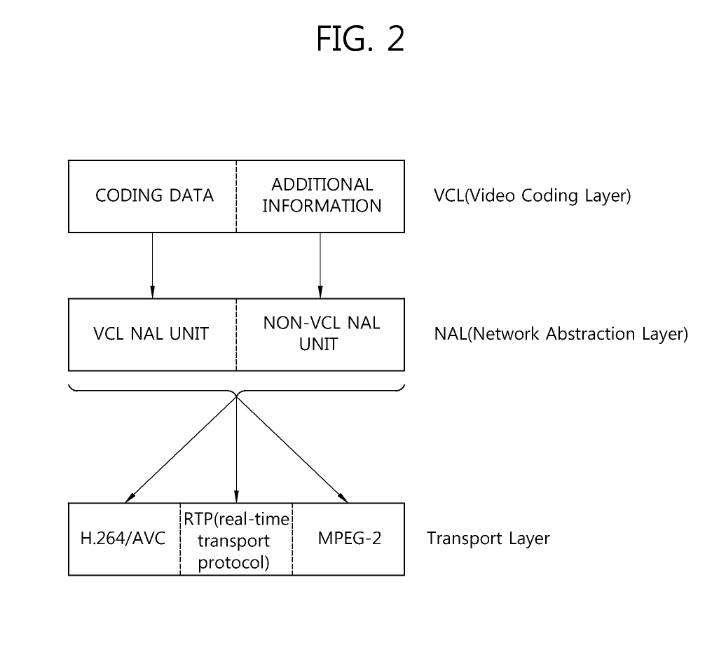

FIG. 2 shows a hierarchical structure of an image stream.

Referring to FIG. 2, the image stream may be configured of a multi-layer.

In the multi-layer, a video coding layer (VCL) is a layer processing the coding of an image. An image signal generated in the video coding layer may include coding data and additional information. The coding data may be image data, and the additional information may be information required for decoding the image data.

A network abstraction layer (NAL) is a layer processing the coding data, the additional information, and the like, processed in the VCL so as to be applied to various transmission layers. For example, in the NAL, the coding data and the additional information processed in the VCL are mapped to a bit stream according to various protocols such as H.264/AVC, real-time transport protocol (RTP), moving picture expert group (MPEG)-2 for broadcasting, and the like.

A transport layer transports image signals according to various protocols such as H.264/AVC, RTP, MPEG-2, and the like.

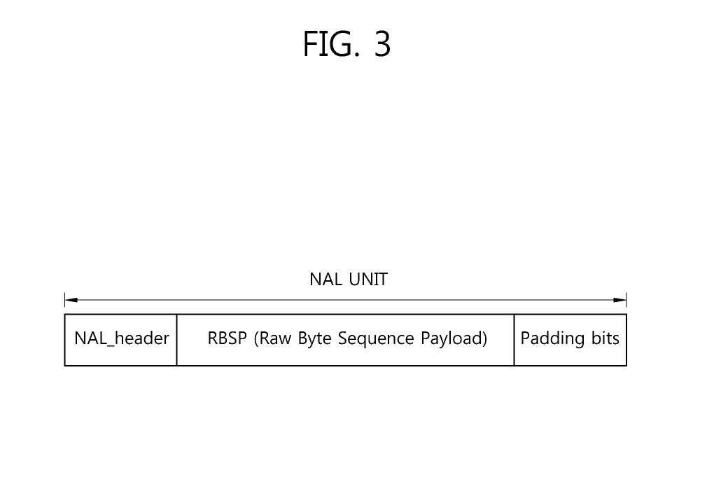

FIG. 3 shows an example a configuration of an image stream.

Referring to FIG. 3, the image stream may be configured in an NAL unit. The NAL unit may include an NAL header, a raw byte sequence payload (RBSP), and padding bits.

The NAL header may include a view parameter (view_id) indicating the number of views of a decoded image obtained by decoding an image stream, a parameter (nal_header_mvc_extension) including information on multi-view extension, a dimensional parameter (nal_unit_type) indicating whether the decoded image is a 2D image or a 3D image, and the like.

The RBSP includes image data generated in the VCL.

The padding bits are bits padded in order to express a length of the RBSP as a multiple of 8 bits.

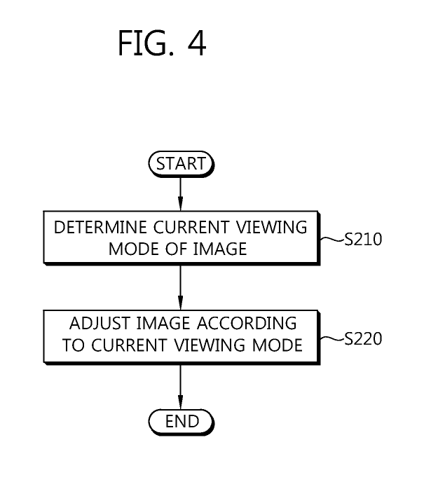

FIG. 4 shows an example of determining whether or not a screen is adjusted in the display apparatus according to the exemplary embodiment of the present invention.

Referring to FIG. 4, the viewing mode determining unit determines a current viewing mode of an image (S210).

The viewing mode determining unit may determine the current viewing mode using information included in an image stream. For example, in the case in which a multi-view extension element such as a ‘nal_header_mvc_extension’ parameter is included in an NAL header of the image stream, the viewing mode determining unit determines that the current viewing mode is a 3D viewing mode. Otherwise, the viewing mode determining unit determines that the current viewing mode is a 2D viewing mode.

Alternatively, the viewing mode determining unit may determine whether an image stream is a stream for a 2D image or a stream for a 3D image through a ‘nal_unit_type’ parameter.

Alternatively, the viewing mode determining unit may determine whether or not the current viewing mode is a 3D viewing mode by judging whether or not the number of sub-streams having the same ‘view_id’ parameter is two or more through the ‘view_id’ parameter. That is, the viewing mode determining unit may determine that the current viewing mode is the 3D image viewing mode in the case in which a view parameter has a value of 2 or more and determine that the current viewing mode is the 2D image viewing mode in the case in which the view parameter has a value of 1 or less.

The viewing mode determining unit may also determine the current viewing mode using a viewing mode stored in the display apparatus. For example, the viewing mode determining unit may also determine that the current viewing mode is the same as a preset viewing mode stored in the memory of the viewing mode signal receiving unit.

Then, the display apparatus of a 3D image adjusts an image according to the current viewing mode (S220).

The screen adjustment determining unit may determine whether or not a screen is adjusted according to the current viewing mode regardless of a previous viewing mode.

Hereinafter, it is assumed that an optimal screen state setting for the 2D image is A and an optimal screen state setting of the 3D image is B. The screen state A may be an optimal screen state for the 2D image, and the screen state B may be an optimal screen state for the 3D image. In other words, optimal {brightness, contrast, hue, saturation, a Gamma value} may be specified according to whether the image is the 2D image or the 3D image.

When the current viewing mode determined by the viewing mode determining unit is the 2D viewing mode, the screen adjusting unit adjusts the display unit so as to become the screen state A by the screen adjustment determining unit. On the other hand, when the current viewing mode determined by the viewing mode determining unit is the 3D viewing mode, the screen adjusting unit adjusts the display unit so as to become the screen state B by the screen adjustment determining unit.

The following Table 1 shows an operation of the screen adjusting unit.

TABLE 1

| | Current Viewing Mode == 3D |
|---|---|
| Current Viewing Mode == 2D Mode | Mode |
| Adjust Screen State to be A | Adjust Screen State to be B |

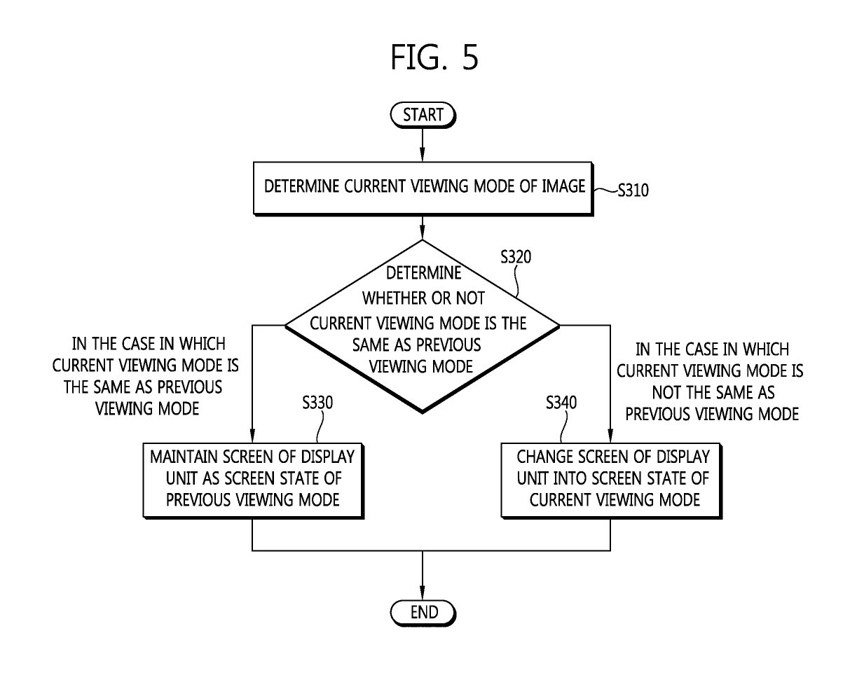

FIG. 5 shows another example of determining whether or not a screen is adjusted in the display apparatus according to the exemplary embodiment of the present invention.

Referring to FIG. 5, the viewing mode determining unit determines a current viewing mode of an image (S310).

The screen adjustment determining unit compares a current viewing mode with a previous viewing mode to determine whether or not the current viewing mode is the same as the previous viewing mode (S320). In the case in which it is determined in the screen adjustment determining unit that the current viewing mode is the same as the previous viewing mode, the screen adjusting unit maintains a screen of the display unit so as to be the same as a screen state of the previous viewing mode (S330).

On the other hand, in the case in which it is determined in the screen adjustment determining unit that the current viewing mode is not the same as the previous viewing mode, the screen adjusting unit changes the screen of the display unit into an optimal screen state of the current viewing mode (S340).

For example, in the case in which the current viewing mode is the same as the previous viewing mode, e.g. in the case in which the previous viewing mode of the image is a 2D viewing mode and the current viewing mode of the image is a 2D viewing mode, the screen adjusting unit maintains the screen of the display unit as a screen state A. On the other hand, in the case in which the current viewing mode of the image is different from the previous viewing mode, e.g. in the case in which the previous viewing mode of the image is a 2D viewing mode and the current viewing mode of the image is a 3D viewing mode, the screen adjusting unit adjusts the screen of the display unit so as to become a screen state B.

The following Table 2 shows an operation of the screen adjusting unit.

TABLE 2

| | Previous Viewing Mode == | Previous Viewing Mode |
|---|---|---|
| | Current Viewing Mode | ≠ Current Viewing Mode |
| Previous | Maintain Screen of Display | Change Screen of Display |
| Screen | Unit as Screen State A | Unit into Screen State B |
| State == | | |
| Optimal for | | |
| Viewing | | |
| Mode A | | |
| Previous | Maintain Screen of Display | Change Screen of Display |
| Screen | Unit as Screen State B | Unit into Screen State A |
| State == | | |
| Optimal for | | |
| Viewing | | |
| Mode B | | |

In a method of adjusting a screen in the display method of a 3D image described above with reference to FIG. 4 or FIG. 5, at least one of elements such as brightness, contrast, hue, saturation, a Gamma value, and the like, is controlled. Among them, the brightness is the most important element. For example, in the case in which a viewer views the 3D image in a state in which he/she wears a polarizing eyeglass, he/she feels that brightness of the image becomes dark. Therefore, in the case in which the display apparatus displays the 3D image, the display apparatus displays the 3D image by automatically adjusting brightness so as to be brighter. That is, the display apparatus may display the image so as to be brighter by setting a value of brightness to a value larger than that of brightness set in the 2D image. Here, contrast, hue, saturation, a Gamma value, and the like, may be additionally adjusted. These values may be predetermined based on experimental results and hardware characteristics of the display apparatus.

According to the exemplary embodiments of the present invention, the display apparatus determines whether a display image is a 2D image or a 3D image and automatically adjusts brightness, contrast, a Gamma value, and the like of the image according to the determination result, thereby making it possible to allow a viewer to view the 2D image or the 3D image without a deterioration phenomenon.

Although the present invention has been described with reference to the embodiments, those skilled in the art will appreciate that various modifications and alterations may be made without departing from the scope and spirit of the invention. Therefore, the present invention is not limited to the above-mentioned embodiment but is intended to include all embodiments falling within the scope defined in the following claims.

What is claimed is:

1. A display method of a 3D image, the display method comprising:
receiving an image stream;
determining a viewing mode of the image stream;
determining whether or not a screen of a display apparatus is adjusted according to the determined viewing mode; and
adjusting the screen of the display apparatus in the case in which it is determined in the determining of whether or not the screen of the display apparatus is adjusted that the screen is adjusted,
wherein the viewing mode of the image stream includes a 2D image viewing mode and a 3D image viewing mode.

2. The display method of claim 1, wherein the image stream includes a header including at least one of a view parameter indicating the number of views of a decoded image obtained by decoding the image stream and a dimensional parameter indicating whether the decoded image is a 2D image or a 3D image.

3. The display method of claim 2, wherein in the determining of the viewing mode of the image stream, the viewing mode of the image stream is determined using at least one of the view parameter and the dimensional parameter.

4. The display method of claim 3, wherein in the determining of the viewing mode of the image stream, it is determined that the viewing mode of the image stream is the 3D image viewing mode in the case in which the number of view parameters is 2 or more, and it is determined that the viewing mode of the image stream is the 2D image viewing mode in the case in which the number of view parameters is 1 or less.

5. The display method of claim 1, wherein in the determining of whether or not the screen of the display apparatus is adjusted, it is determined that the screen is adjusted only in the case in which the determined viewing mode is different from a previous viewing mode.

6. The display method of claim 1, wherein the adjusting of the screen includes changing at least one of brightness, contrast, hue, saturation, and a Gamma value of the display apparatus.

7. The display method of claim 6, wherein in the case in which it is determined that the viewing mode of the image stream is the 3D viewing mode, the brightness of the display apparatus is adjusted so as to have a value larger than that of brightness set in the 2D image viewing mode.

8. A display apparatus of a 3D image, the display apparatus comprising:
a viewing mode determining unit receiving an image stream and determining a viewing mode of the image stream;
a screen adjustment determining unit determining whether or not a screen is adjusted according to the viewing mode determined by the viewing mode determining unit;
a screen adjusting unit adjusting the screen according to the determination of the screen adjustment determining unit; and
a display unit connected to the screen adjusting unit, displaying an image, and receiving image control signals from the screen adjusting unit to adjust a display method of the image,
wherein the viewing mode of the image stream includes a 2D image viewing mode and a 3D image viewing mode.

9. The display apparatus of claim 8, wherein the image stream includes a header including at least one of a view parameter indicating the number of views of a decoded image obtained by decoding the image stream and a dimensional parameter indicating whether the decoded image is a 2D image or a 3D image.

10. The display apparatus of claim 9, wherein the viewing mode determining unit determines whether the image stream is the 3D image using at least one of the view parameter and the dimensional parameter.

11. The display apparatus of claim 10, wherein the viewing mode determining unit determines that the viewing mode of the image stream is the 3D image viewing mode in the case in which the number of view parameters is 2 or more, and determines that the viewing mode of the image stream is the 2D image viewing mode in the case in which the number of view parameters is 1 or less.

12. The display apparatus of claim 8, wherein the screen adjustment determining unit determines that the screen is adjusted only in the case in which the viewing mode determined by the viewing mode determining unit is different from a previous viewing mode.

13. The display apparatus of claim 8, wherein the screen adjusting unit adjusts the screen of the display unit by changing at least one of brightness, contrast, hue, saturation, and a Gamma value.

14. The display apparatus of claim 13, wherein in the case in which it is determined that the viewing mode of the image stream is the 3D viewing mode, the screen adjusting unit adjusts the brightness of the display unit so as to have a value larger than that of brightness set in the 2D image viewing mode.
